(19) United States
(12) Patent Application Publication
(10) Pub. No.: US 2008/0050228 A1
(43) Pub. Date: Feb. 28, 2008

(54) Impeller Structure and the Centrifugal Fan Device Using the Same

(75) Inventors: Jiing-Fu Chen, Hsinchu City (TW); Tung-Chuan Wu, Hsinchu City (TW); Chan-Hsing Lo, Hsinchu County (TW); Chung-Ping Chiang, Taipei County (TW); Yu-Liang Chung, Taipei City (TW); Yann-Shuoh Sun, Taipei County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE

(21) Appl. No.: 11/533,554

(22) Filed: Sep. 20, 2006

(30) Foreign Application Priority Data
Aug. 25, 2006 (TW) 095131240

(51) Int. Cl. F03B 3/16

(52) U.S. Cl. 415/204

(57) ABSTRACT

An impeller structure for a centrifugal fan device is disclosed, in which the impeller structure is primarily comprised of: a disc; and a plurality of blade structures, each being arranged on the disc; wherein, each blade structure further comprises: a first blade; and a second blade, arranged at a circumferential length away from a side of the first blade while radially overlapping with the radial of the first blade by a specific overlap area for forming a gap passage functioning as a nozzle. As a fluidic is flowing through and shooting out of the gap passage, not only the growth of the boundary layers on the suction surfaces of front blades are interrupted, but also as the fluidic with high kinetic energy is mixing with the low-kinetic fluidic flowing on the suction surfaces of rear blades, the thickness of the boundary layer is reduced while the separation point is delayed and thus separation can be prevented.

### FIELD OF THE INVENTION

The present invention relates to an impeller structure, and more particularly, to an impeller structure for a centrifugal fan device, in which each blade structure of the impeller structure is primarily comprised of: a first blade; and a second blade, arranged at a circumferential length away from a side of the first blade while radially overlapping with the radial of the first blade by a specific overlap area for forming a gap passage functioning as a nozzle.

### BACKGROUND OF THE INVENTION

As centrifugal impeller is the heart of a centrifugal fan, it plays an important role in factors affecting the performance and noise of the centrifugal fan. Centrifugal fans are subclassified in the literature according to their impeller and blade designs. The impeller and blade designs employed in the commercially available centrifugal fans are the backward curved, radial, and forward curved. Of these, the backward curved type has been recognized as being most efficient and producing least noise. Moreover, there are two types of blades used in the backward curved type centrifugal impeller, which are plate type and airfoil type. Among those, the backward curved type centrifugal impeller employing airfoil blades is most efficient and can produce least fan noise.

It is noted that any blade used in every conventional centrifugal impeller employing airfoil blades is designed as single-blade, as those shown in FIG. 1 illustrating a top view of a conventional centrifugal impeller employing airfoil blades of signal-blade design. In a flow field of the conventional centrifugal impeller of FIG. 1, generated when a fluidic is flowing passing a blade 10 of the rotating impeller 1, a pressure surface 102 and a suction surface 101 can be identified and classified on the blade 10 as the fluidic is subjected to the influence of centrifugal force, Coriolis force and the geometry of the blade 10. From the relative velocity point of view, the decelerating process of the fluidic happening on the suction surface 101 of the blade 10 is much more drastic than that on the pressure surface 101, that along with the pushing of low-kinetic fluidic to the suction surface 101 by secondary flow will cause the thickness of suction surface boundary layer to increase dramatically, facilitating the separation of boundary layer. Therefore, not only the energy lost in the impeller is increased, but also the wake generated at the outlet area of the impeller is increased that causes high mixing loss at the outlet thereof. In addition, noises will occur along with the separation and unevenness of flow field.

In U.S. Pat. No. 4,615,659, entitled “Offset Centrifugal Compressor”, an offset centrifugal impeller is disclosed, in which each blade of the impeller is formed of at least three blade parts extending generally end-to-end while enabling the adjacent end of adjacent pairs of blade parts to be offset slightly. However, the abovementioned offset centrifugal impeller is not only complicated in structure that it is difficult to process, but also it is difficult to design and analyze.

Therefore, it is in need of an impeller structure and centrifugal fan device using the same, which are freed from the problems of prior arts.

### SUMMARY OF THE INVENTION

It is the primary object of the present invention to provide an impeller structure for a centrifugal fan device, in which each blade structure is comprised of two blades, radially overlapping with each other for forming a gap passage functioning as a nozzle, such that, as a fluidic is flowing through and shooting out of the gap passage, not only the growth of boundary layer can be interrupted, but also the thickness of the boundary layer is reduced.

It is another object of the present invention to provide an impeller structure for a centrifugal fan device, in which each blade structure is comprised of two blades, radially overlapping with each other for forming a gap passage functioning as a nozzle, such that, as a fluidic is flowing through and shooting out of the gap passage, the separation point is delayed or even prevented for reducing energy loss caused by the separation and flow mixing.

Yet, another object of the present invention is to provide an impeller structure for a centrifugal fan device, in which each blade structure is comprised of two blades, radially overlapping with each other for forming a gap passage functioning as a nozzle, by which the noise of the impeller structure can be reduced.

To achieve the above object, the present invention provide an impeller structure, comprising: a disc; and a plurality of blade structures, each being arranged on the disc; wherein, each blade structure further comprises: a first blade; and a second blade, arranged at a position with respect to a side of the first blade while radially overlapping with the radial of the first blade by a overlap area.

Preferably, the plural blade structures are arranged on the disc in an annular manner.

Preferably, the ratio of the radial blade length of the second blade, referring as Cr hereinafter, over the radial blade length of the first blade, referring as Cf hereinafter, is in the range of 0.8˜2.0.

Preferably, the ratio of a pitch defining the overlapping area, referring as Rol hereinafter, over the radial blade length of the first blade (Cf), i.e. Rol/Cf, is in the range of 0˜0.2.

Preferably, a circumferential length of the overlapping area is defined by a distance between a leading edge of the second blade and a trailing edge of the first blade; wherein, the ratio of the circumferential length, referring as t hereinafter, over the radial distance between trailing edges of two adjacent first blades (s), i.e. t/s, is in the range of 0.05˜0.15.

To achieve the above object, the present invention provide a centrifugal fan device, comprising: a volute shell, having a fluidic outlet and a fluidic inlet; a disc, arranged inside the volute shell, having a plurality of blade structures formed thereon; and a shaft, having an end connecting to the center of disc and another end connecting to a driving apparatus; wherein, each blade structure further comprises: a first blade; and a second blade, arranged at a position with respect to a side of the first blade while radially overlapping with the radial of the first blade by a overlap area.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a top view of a conventional centrifugal impeller employing airfoil blades of signal-blade design.

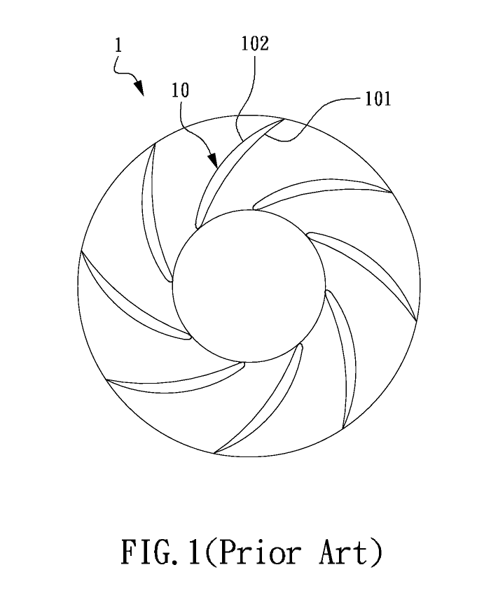

FIG. 2A is a top view of an impeller structure according to a preferred embodiment of the invention.

FIG. 2B is a cross sectional view of FIG. 2A.

FIG. 3 and FIG. 4 are schematic diagrams depicting a blade structure of the invention.

FIG. 5 is a cross sectional view of a centrifugal fan device according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

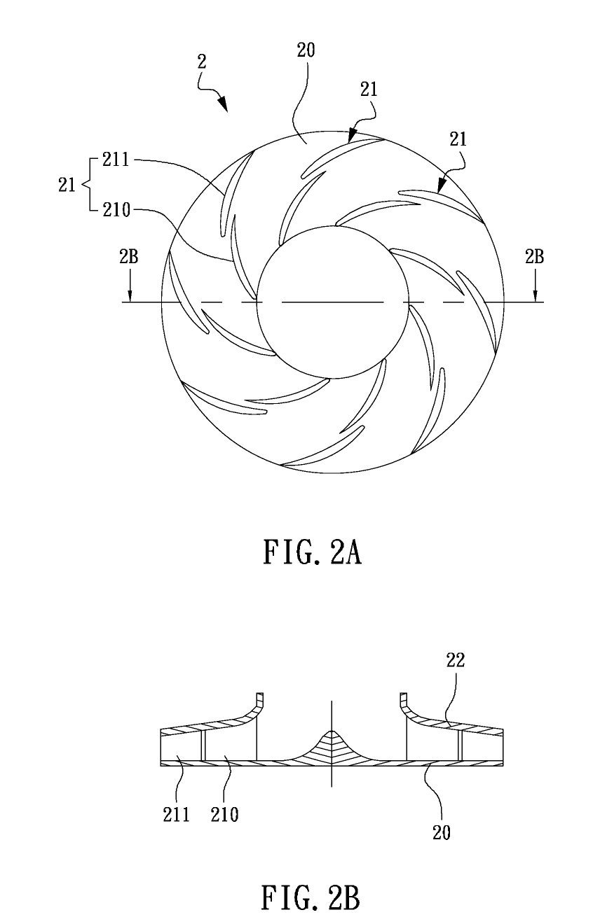

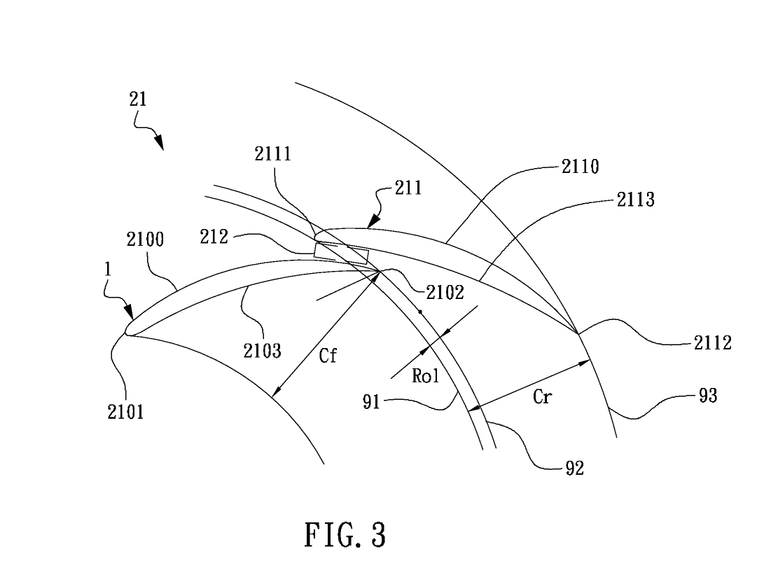

Please refer to FIG. 2A and FIG. 2B, which are top view and a cross sectional view of an impeller structure according to a preferred embodiment of the invention. The impeller structure 2 is comprised of: a disc 20; and a plurality of blade structures 21, each being arranged on the disc 20 and connected to each other by a front cap 22; wherein, each blade structure 21 further comprises: a first blade 210; and a second blade 211, arranged at a circumferential length away from a side of the first blade 210 while radially overlapping with the radial of the first blade 210 by a overlap area. In this preferred embodiment, the plural blade structures are arranged on the disc 20 in an annular manner.

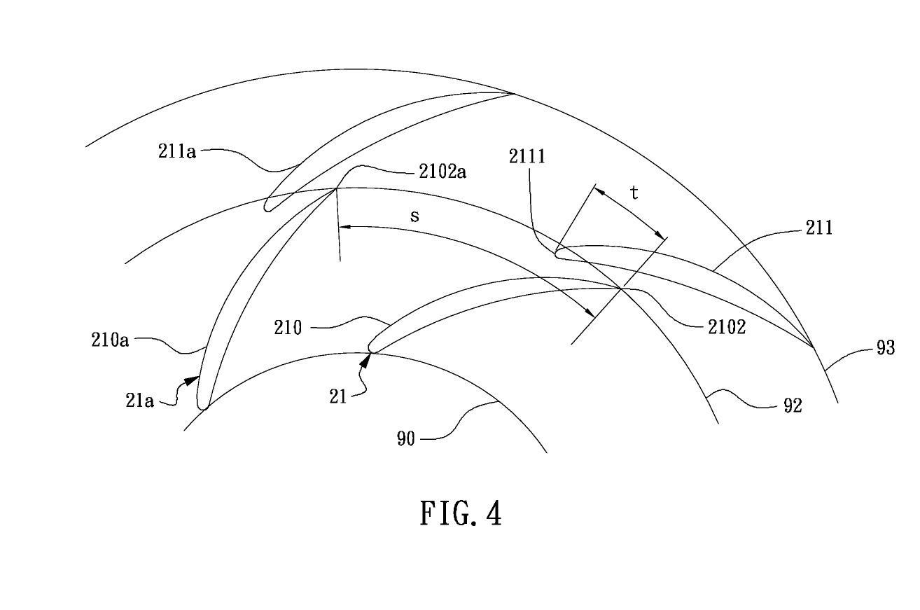

Please refer to FIG. 3 and FIG. 4, which are schematic diagrams depicting a blade structure of the invention. The blade structure of the invention is improved over the prior-art single airfoil blade, that is, it is a blade structure of two-blade design, referring as the first blade 210 and the second blade 211. Similarly, a pressure surface 2100 and a suction surface 2103 can be identified and classified on the first blade 210 while a pressure surface 2110 and a suction surface 2113 can be identified and classified on the second blade 211. As seen in FIG. 3, the relative position of the first and the second blades is that: the second blade 211 is arranged at a circumferential length away from a side of the first blade 210 by enabling the leading edge 2111 of the second blade's 211 suction surface 2113 to be positioned in the proximity of the trailing edge 2102 of the first blade's 210 pressure surface 2100 while radially overlapping with the radial of the first blade by a specific overlap area for forming a gap passage 212 functioning as a nozzle. As a fluidic is flowing through and shooting out of the gap passage 212, not only the growth of the boundary layer on the suction surfaces 2103 of the first blade 210 is interrupted, but also as the fluidic with high kinetic energy is mixing with the low-kinetic fluidic flowing on the suction surface 2113 of the second blade 211, the thickness of the boundary layer is reduced while the separation point is delayed and thus separation can be prevented. Therefore, not only the separation loss and the missing loss are reduced, but also the fan noise is reduced since the flow field is more uniform as the generation of vortex is improved. To sum up, the uniformity of the flow field of the impeller is improved by the improvement of the blade structure thereof for the growth of the boundary layers on the suction surfaces of the blades are interrupted.

In a preferred aspect, the ratio of the radial blade length of the second blade, referring as Cr, over the radial blade length of the first blade, referring as Cf, is in the range of 0.8˜2.0, in which Cr is defined as the difference between a radius of a circle 93, defining by the center of the disc 20 and the trailing edge 2112 of the second blade 211, and a radius of a circle 91, defining by the center of the disc 20 and the leading edge 2111 of the second blade 211, and Cf is defined as the difference between a radius of a circle 92, defining by the center of the disc 20 and the trailing edge 2102 of the first blade 210, and a radius of a circle 90, defining by the center of the disc 20 and the leading edge 2101 of the first blade 210. Moreover, the ratio of a pitch defining the overlapping area, referring as Rol, over the radial blade length of the first blade (Cf), i.e. Rol/Cf, is in the range of 0˜0.2, in which Rol is defined as the difference between the radius of the circle 92 and the radius of the circle 91.

In addition, as seen in FIG. 4, the ratio of the circumferential length, referring as t and being defined as a distance between a leading edge 2111 of the second blade 211 and a trailing edge 2102 of the first blade 210, over the radial distance between trailing edges 2102, 2102a of two adjacent first blades 210, 210a, referring as s, i.e. t/s, is in the range of 0.05˜0.15.

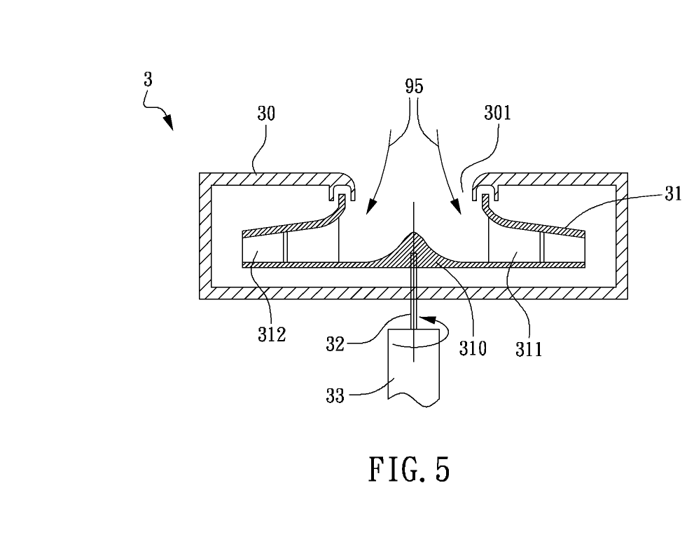

Please refer to FIG. 5, which is a cross sectional view of a centrifugal fan device according to the present invention. The centrifugal fan device 3 is comprised of a volute shell 30, a centrifugal impeller structure 31 and a shaft 32. The volute shell 30 has a fluidic outlet and a fluidic inlet 301. The centrifugal impeller structure 31 is arranged inside the volute shell 30, that is further comprised of a disc 310 having a plurality of blade structures formed thereon, wherein, each blade structure further comprises: a first blade 311; and a second blade 312, arranged at a circumferential length away from a side of the first blade 311 while radially overlapping with the radial of the first blade by a overlap area. It is noted that the relative position of the first and the second blade is similar to that shown in FIG. 2 and thus is not described further herein. The shaft 32 has an end connecting to the center of disc 310 and another end connecting to a driving apparatus 33, whereas the driving apparatus 33 is used for proving power to the shaft 32 and bringing along the disc 310 to rotate, such that the impeller structure 31 is activated.

As a fluidic 95 is flowing into the centrifugal fan device 3 through the fluidic inlet 301, the shaft 32 is driven to rotate by the driving apparatus 33 for bringing along the centrifugal impeller structure 31 rotate and thus the energy of the flowing fluidic is raised. Thereafter, the flowing fluidic is discharge from the outlet of the impeller structure 31 and enters the volute shell 30 to be decelerated and expanded, and eventually, discharged from the outlet of the volute shell 30. It is noted that, not only the blade design of the impeller structure 31 can enable the growth of the boundary layer on the suction surfaces of the first blade to be interrupted, but also as the fluidic with high kinetic energy is mixing with the low-kinetic fluidic flowing on the suction surface of the second blade, the thickness of the boundary layer is reduced while the separation point is delayed and thus separation can be prevented. Therefore, not only the separation loss and the missing loss are reduced, but also the fan noise of the centrifugal fan device 3 is reduced since the flow field is more uniform as the generation of vortex is improved. To sum up, the uniformity of the flow field of the centrifugal fan device 3 is improved by the improvement of the uniformity of flow field and the generation of vortex.

To sum up, by the use of the impeller structure of the invention, not only the growth of the boundary layers on the suction surfaces of front blades are interrupted, but also as the fluidic with high kinetic energy is mixing with the low-kinetic fluidic flowing on the suction surfaces of rear blades, the thickness of the boundary layer is reduced while the separation point is delayed and thus separation can be prevented.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An impeller structure, comprising:
a disc; and
a plurality of blade structures, each being arranged on the disc; each blade structure further comprises:
a first blade; and
a second blade, arranged at a position with respect to a side of the first blade while radially overlapping with the radial of the first blade by a overlap area.

2. The impeller structure of claim 1, wherein the plural blade structures are arranged on the disc in an annular manner.

3. The impeller structure of claim 1, wherein the ratio of the radial blade length of the second blade, referring as Cr, over the radial blade length of the first blade, referring as Cf, is in the range of 0.8˜2.0.

4. The impeller structure of claim 1, wherein the ratio of a pitch defining the overlapping area, referring as Rol, over the radial blade length of the first blade (Cf), i.e. Rol/Cf, is in the range of 0˜0.2.

5. The impeller structure of claim 1, wherein a circumferential length of the overlapping area is defined by a distance between a leading edge of the second blade and a trailing edge of the first blade.

6. The impeller structure of claim 5, wherein the ratio of the circumferential length, referring as t, over the radial distance between trailing edges of two adjacent first blades (s), i.e. t/s, is in the range of 0.05˜0.15.

7. A centrifugal fan device, comprising:
a volute shell, having an fluidic outlet and a fluidic inlet;
an centrifugal impeller, arranged inside the volute shell, further comprising:
a disc, having a plurality of blade structures formed thereon;
and
a shaft, having an end connecting to the center of disc and another end connecting to a driving apparatus;
wherein, each blade structure further comprises:
a first blade; and
a second blade, arranged at a position with respect to a side of the first blade while radially overlapping with the radial of the first blade by a overlap area.

8. The impeller structure of claim 7, wherein the plural blade structures are arranged on the disc in an annular manner.

9. The impeller structure of claim 7, wherein the ratio of the radial blade length of the second blade, referring as Cr, over the radial blade length of the first blade, referring as Cf, is in the range of 0.8˜2.0.

10. The impeller structure of claim 7, wherein the ratio of a pitch defining the overlapping area, referring as Rol, over the radial blade length of the first blade (Cf), i.e. Rol/Cf, is in the range of 0˜0.2.

11. The impeller structure of claim 7, wherein a circumferential length of the overlapping area is defined by a distance between a leading edge of the second blade and a trailing edge of the first blade.

12. The impeller structure of claim 11, wherein the ratio of the circumferential length, referring as t, over the radial distance between trailing edges of two adjacent first blades (s), i.e. t/s, is in the range of 0.05˜0.15.
